(19) United States
(12) Patent Application Publication
(10) Pub. No.: US 2013/0205059 A1
(43) Pub. Date: Aug. 8, 2013

(54) MOTHERBOARD COMPRISING EXPANSION CONNECTOR

(71) Applicant: MENG-LIANG YANG, Shenzhen (CN)

(72) Inventor: MENG-LIANG YANG, Shenzhen (CN)

(21) Appl. No.: 13/705,185

(22) Filed: Dec. 5, 2012

(30) Foreign Application Priority Data
Feb. 7, 2012 (CN) 201210026298.4

(51) Int. Cl. G06F 13/40

(52) U.S. Cl. CPC G06F 13/4022
USPC 710/300

(57) ABSTRACT

A motherboard includes a CPU, an expansion connector detachably connected to an expansion card, a controller, and a switch. The switch is electronically connected to the CPU, the expansion connector and the controller, the switch may be made to switch connections between the expansion connector and one of the CPU and the controller, according to a type of the expansion card which is installed.

### BACKGROUND

1. Technical Field

The disclosure generally relates to motherboards, particularly to a motherboard comprising an expansion connector.

2. Description of Related Art

In order to increase storage space, an expansion connector can be mounted to a motherboard to install an expansion card that supports mass storage devices such as hard disk drives. The motherboard communicates with the expansion card via the expansion connector.

Some expansion connectors can transmit two types of signals. In use, if a type of signal transmitted from the motherboard is different from the type of expansion card installed to the motherboard, the expansion card cannot be used, and may even be damaged.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 shows a block diagram of an exemplary embodiment of a motherboard comprising an expansion connector.

FIG. 2 shows an exploded view of a switching control unit of the motherboard shown in FIG. 1.

### DETAILED DESCRIPTION

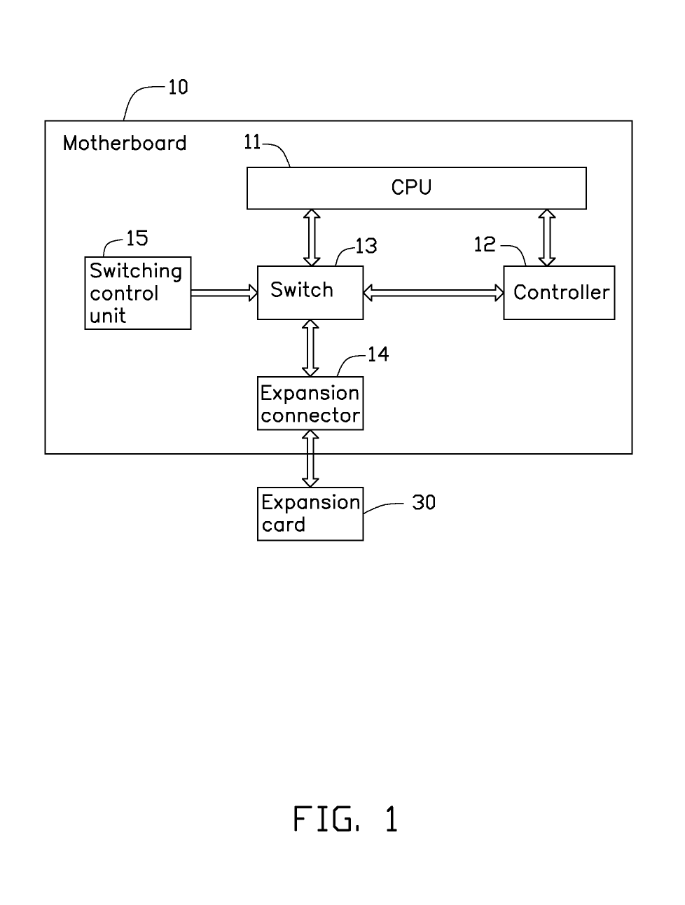

FIG. 1 shows a block diagram of an exemplary embodiment of a motherboard 10 including an expansion connector 14. The motherboard 10 can be used in a terminal device, such as a personal computer or a server for example. An expansion card 30 can be installed in the motherboard 10 for mass storage support, using devices, such as hard disk drives, to increase storage capacity of the motherboard 10. The motherboard 10 further includes a CPU 11, a controller 12 electronically connected to the CPU 11, a switch 13 electronically connected to the CPU 11, the expansion connector 14 and the controller 12, and a switching control unit 15 electronically connected to the switch 13. The CPU 11 is physically and electronically connected to the controller 12 and the switch 13 by a differential pair of transmission lines. The switch 13 is physically and electronically connected to the controller 12 and the expansion connector 14 also by a differential pair of transmission lines. In one embodiment, the controller 12 is a platform controller hub (PCH).

The CPU 11 can transmit a first bus signal to the switch 13. The controller 12 can transmit a second bus signal to the switch 13. The CPU 11 can transmit a third bus signal to the controller 12. In the exemplary embodiment, the first bus signal is a peripheral component interconnect-express (PCIE) signal, the second bus signal is a serial attached SCSI (SAS) signal, and the third bus signal is a direct media interface (DMI) signal.

The expansion connector 14 is detachably connected to the expansion card 30. In one embodiment, the expansion connector 14 is a PCIE connector, which can transmit both PCIE signals and SAS signals. Therefore, the expansion connector 14 can selectively connect to an expansion card of the PCIE type or the SAS type.

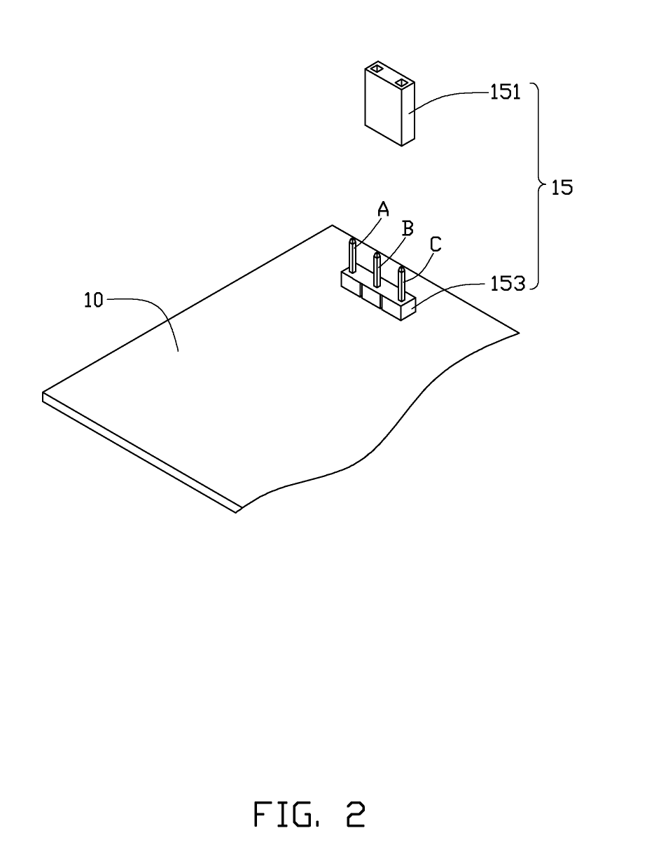

FIG. 2 shows an exploded view of the switching control unit 15 of the motherboard 10 shown in FIG. 1. The switching control unit 15 switches the switch 13, that is, the switching control unit 15 can be manually operated to control the switch 13 to switch signal paths, and accordingly switch connections between the expansion connector 14 and one of the CPU 11 and the controller 12. In the exemplary embodiment, the switching control unit 15 includes a jumper 151 and a jumper block 153. The jumper block 153 is mounted on the motherboard 10, and includes a plurality of jumper pins, such as a jumper pin A, a jumper pin B, and a jumper pin C, in the exemplary embodiment. The three jumper pins A, B, and C are electronically connected to the switch 13. The jumper 151 functions as a shorted socket, having two holes defined therein for selectively being slipped over two jumper pins of the jumper block 153, to construct an electronic connection between two jumper pins, thereby switching the switch 13.

For example, when a PCIE expansion card 30 is installed in the motherboard 10 to connect to an external device, such as a display for example, the jumper 151 is slipped over the jumper pins A and B, to make an electrical connection between the pin jumper pins A and B, and the switch 13 then connects the expansion connector 14 to the CPU 11 to construct a signal path between the CPU 11 and the expansion connector 14 for transmitting PCIE signals. When a SAS expansion card 30 is installed in the motherboard 10, the jumper 151 is slipped over the jumper pins B and C, to make an electrical connection between the jumper pins B and C, and thus the switch 13 connects the expansion connector 14 to the controller 12 to construct a signal path between the controller 12 and the expansion connector 14 for transmitting SAS signals.

Therefore, the switch 13 can selectively connect the expansion connector 14 to one of the motherboard 10 and the controller 12, under the control of the switching control unit 15, according to the type of the expansion card 30, to avoid signals of the incorrect type being transmitted to the installed expansion card 30, and consequent damage to the expansion card 30.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A motherboard, comprising:
a central processing unit (CPU);
an expansion connector detachably connected to an expansion card;
a controller; and
a switch electronically connected to the CPU, the expansion connector and the controller, the switch receiving a first bus signal and a second bus signal from the CPU and the controller respectively, and selectively transmitting one of the first and second bus signals to the expansion card, according to a type of the expansion card.

2. The motherboard of claim 1, wherein the expansion connector is a PCIE connector that selectively connects to an expansion card of the PCIE type or the SAS type.

3. The motherboard of claim 1, further comprising a switching control unit, wherein the switching control unit comprises a jumper and a jumper block electronically connected to the switch, the jumper block comprises a plurality of jumper pins, the jumper selectively constructs an electronic connection between different two jumper pins according to the type of the expansion card, to control the switch to switch signal paths of the bus signals.

4. The motherboard of claim 1, wherein the first bus signal is a peripheral component interconnect-express (PCIE) signal, and the second bus signal is a serial attached SCSI (SAS) signal.

5. The motherboard of claim 4, wherein the CPU transmits direct media interface (DMI) signal to the controller.

6. The motherboard of claim 1, wherein the controller is a platform controller hub (PCH).

7. A motherboard, comprising:
a CPU;
an expansion connector detachably connected to an expansion card;
a controller; and
a switch electronically connected to the CPU, the expansion connector and the controller, the switch switching connections between the expansion connector and one of the CPU and the controller, according to a type of the expansion card.

8. The motherboard of claim 7, wherein the switch transmits PCIE signal and SAS signal with the CPU and the controller respectively, the expansion connector is a PCIE connector that selectively connects an expansion card of the PCIE type or the SAS type.

9. The motherboard of claim 8, wherein the CPU transmits DMI signal to the controller.

10. The motherboard of claim 7, further comprising a switching control unit, wherein the switching control unit comprises a jumper and a jumper block electronically connected to the switch, the jumper block comprises a plurality of jumper pins, the jumper is selectively slipped over two jumper pins according to the type of the expansion card, to switch connections between the expansion connector and one of the CPU and the controller.

11. The motherboard of claim 7, wherein the controller is a platform controller hub.
